(19) United States
(12) Patent Application Publication
(10) Pub. No.: US 2014/0244243 A1
(43) Pub. Date: Aug. 28, 2014

(54) APPARATUS AND METHOD FOR PROVIDING INPUT PREDICTION SERVICE

(71) Applicant: PANTECH CO., LTD., Seoul (KR)

(72) Inventors: Ju-Yong Kim, Seoul (KR); Hyuck-Jin Kim, Seoul (KR); Sang-Ryun Yu, Paju-si (KR)

(73) Assignee: PANTECH CO., LTD., Seoul (KR)

(21) Appl. No.: 14/136,654

(22) Filed: Dec. 20, 2013

(30) Foreign Application Priority Data
Feb. 25, 2013 (KR) 10-2013-0019951

(51) Int. Cl. G06F 17/25

(52) U.S. Cl. CPC G06F 17/25
USPC 704/9

(57) ABSTRACT

A method for providing an input prediction service in a first mobile terminal, the method includes receiving a message, from a second mobile terminal, at the first mobile terminal using a first application program, extracting specific text included in the received message, and identifying prediction information based on the extracted text. An apparatus to provide an input prediction service in a first mobile terminal, the apparatus includes a first application program to receive a message from a second mobile terminal, and a recognition unit to extract specific text included in the receive message and to identify prediction information based on the extracted text.

### CROSS-REFERENCE TO RELATED APPLICATION

This application claims priority and the benefit under 35 U.S.C. §119(a) of a Korean Patent Application No. 10-2013-0019951, filed on Feb. 25, 2013, the entire disclosure of which is incorporated herein by reference for all purposes.

### BACKGROUND

1. Field

The following description relates to an apparatus and method for providing an input prediction service.

2. Discussion of the Background

With advancement of mobile devices, various kinds of mobile devices are being developed and expanding in supply. Mobile devices provide various services or application programs that are used according to a text input from a user. With the introduction of various text based messenger services (e.g., various kinds of mobile messengers) in addition to a short message service (SMS) in the existing mobile devices, a text input-based service is being variously used.

Text-based prediction technology, such as an auto-complete text operation, has been developed for providing convenience to a user in inputting a text. Text-based prediction technology, which is generally used to recognize a user's input, searches for text information stored in a database to find the user's recognized text input, predicts text information associated with the text which is being currently input from the user, and provides the predicted text information to the user. For example, when a user inputs a few letters of a word or a few words in a sentence, the text-based prediction technology may search for a word or sentence predicted from the inputted letters or words to provide a completed or predicted type of word or sentence to the user. Therefore, the user can provide a desired word or sentence without personally inputting all letters of a word or all words in a sentence.

An inputting method by predicting character sequence and an electronic device for practicing the method may include a character sequence prediction input method that can select a desired character sequence by inputting only some letters. Through this method, a user can select a desired character sequence by inputting only some letters, and thus can input a character sequence more easily and quickly.

The text-based prediction technology compares a user inputted text with contents stored in a database to predict only a completed word or sentence, and thus merely enables a user to input a text more quickly. There are technologies that partially predict the writing intent or purpose of a user through a method using a related keyword. However, the related keyword technologies merely compare a user inputted text with words or sentences stored in a database to provide a predicted word or sentence.

### SUMMARY

Exemplary embodiments of the present invention provide an apparatus and method for providing an input prediction service.

Additional features of the invention will be set forth in the description which follows, and in part will be apparent from the description, or may be learned by practice of the invention.

Exemplary embodiments of the present invention provide a method for providing an input prediction service in a first mobile terminal, the method including receiving a message, from a second mobile terminal, at the first mobile terminal using a first application program; extracting specific text included in the received message; and identifying prediction information based on the extracted text.

Exemplary embodiments of the present invention provide an apparatus to provide an input prediction service in a first mobile terminal, the apparatus including a first application program to receive a message from a second mobile terminal; and a recognition unit to extract specific text included in the receive message, and to identify prediction information based on the extracted text.

Exemplary embodiments of the present invention provide an apparatus to provide an input prediction service in a first mobile terminal, the apparatus including a first application program to receive a message from a second mobile terminal; a recognition unit to extract specific text included in the receive message, and to identify prediction information based on the extracted text; a data storage unit to store interoperation data of a second application program; and a processing unit to retrieve interoperation data of the second application program, and to generate a prediction list using the interoperation data.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating an apparatus to provide an input prediction service according to an exemplary embodiment of the present invention.

FIG. 2 is a flowchart illustrating a data flow for providing input prediction service according to an exemplary embodiment of the present invention.

FIG. 3 is a flowchart illustrating a method for providing an input prediction service according to an exemplary embodiment of the present invention.

FIG. 4 is a diagram illustrating an input device interface to provide an input prediction service according to an exemplary embodiment of the present invention.

FIG. 5A, FIG. 5B, and FIG. 5C are diagrams illustrating an integrated input interface to provide an input prediction service interoperating with a gallery application program is according to an exemplary embodiment of the present invention.

FIG. 6 is a diagram illustrating an apparatus to provide an input prediction service using a pre-interoperation scheme according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

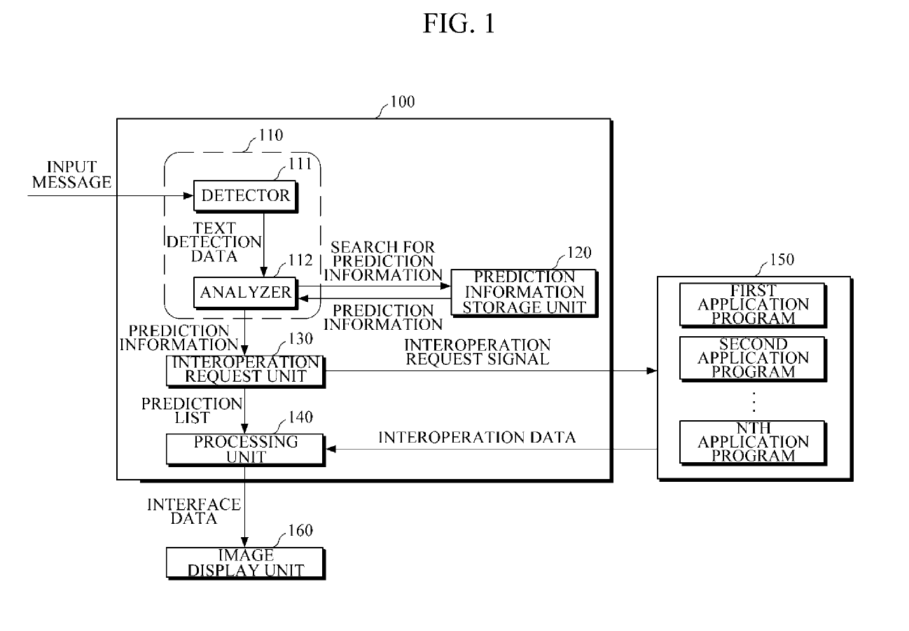

FIG. 1 is a diagram illustrating an apparatus to provide an input prediction service according to an exemplary embodiment of the present invention.

Referring to FIG. 1, an apparatus 100 to provide input prediction service includes a recognition unit 110, a prediction information storage unit 120, an interoperation request unit 130, and a processing unit 140. According to aspects of the invention, the apparatus 100 may be installed or integrated in a mobile terminal. A mobile terminal may include hardware components, such as one or more processors, a memory, a touch screen display, a camera, and the like. Also, the units, modules, elements, devices, applications, and components of the apparatuses, systems, and/or mobile terminals may include hardware and software, may also include firmware, to perform various operations of the mobile terminal, may be combined or remain separate, and may be stored in one or more storage devices or computer-readable media. In an example, mobile terminal may be a cellular telephone, a smartphone, a tablet computer, a laptop computer, a desktop computer, and the like.

The recognition unit 110 includes a detector 111 and an analyzer 112.

The detector 111 may detect receiving of a message and/or a text included in the received message. More specifically, the recognition unit 110 may detect a text input from a user, who may personally input the text using a corresponding input unit of a mobile terminal, and may also detect a text received from another party. While conventional input prediction technology detects only a text which a user inputs directly or personally, the recognition unit 110 may detect both a text inputted by a user and/or a text received from the other party.

The recognition unit 110 may detect a text from a text-based message, which may be sent and/or received by various services including, without limitation, a short message service (SMS), a multi-media message service (MMS), a mobile messenger, and the like. The detector 111 may recognize a received message and/or detect one or more texts (e.g., letters, characters, words, phrases, sentence, and the like) included in the message. For example, when a message is received through the mobile messenger or other text exchange communication service, the detector 111 may detects some or all texts included in the received message. Furthermore, the detector 111 may generate text detection data, which may include one or more of the detected texts, and transfer the text detection data to the analyzer 112.

The analyzer 112 may parse the text or texts included in the text detection data received from the detector 111 to extract a specific text, which may be manually or automatically selected, from the text detection data or a text interoperable with other application program(s). According to aspects of the invention, the received text detection data may include a plurality of texts. The analyzer 112 may parse the plurality of texts to extract one or more words from the text detection data. For example, when the text detection data detected by the detector 111 includes a text of ‘Do you happen to know the phone number of Hong Kil-dong’, the analyzer 112 may extract words ‘Hong Kil-dong’ and ‘phone number’ from the text detection data.

The analyzer 112 may search for prediction information in the prediction information storage unit 120 based on one or more extracted words. The prediction information may include, without limitation, at least one of potential word(s), phrase(s), contact information, date(s), image(s), file(s), sentence(s), contextual information or the like, predicted according to a combination of two or more words. The analyzer 112 may search for prediction information in the prediction information storage unit 120 corresponding to a combination of words extracted by the analyzer 112. The analyzer 112 may parse the text detection data, and search for prediction information that may determine or indicate the meaning or purpose of the extracted combination of words. More specifically, the analyzer 112 may search for and/or identify prediction information, which may include one or more potential words or sentences, based on the words extracted by the analyzer 112. Also, the analyzer 112 may search for prediction information to predict a complete word based on a combination of two or more characters to provide an auto-complete operation. According to aspects of the invention, the analyzer 112 may search for prediction information to predict a complete word based on characters received from an external device or terminal and not just a mobile terminal of the user. Furthermore, the analyzer 112 may transfer the identified prediction information to the interoperation request unit 130.

The prediction information storage unit 120 may transfer requested or searched prediction information to the analyzer 112. The prediction information may include a potential sentence predicted based on a combination of two or more words or contextual information, such as a meaning or indication, based on the combined words. The prediction information of the prediction information storage unit 120 may enable prediction of a potential sentence using the extracted words. Further, the prediction information may enable prediction of a complete word, phrase or a related word of the extracted word(s) used to search for the prediction information. According to aspects of the invention, search for prediction information need not be limited to a combination of two or more words, such that prediction information may be searched for based on a combination or letters or a single word.

For example, the analyzer 112 may extract two words ‘Hong Kil-dong’ and ‘phone number’ through a parsing operation, and search for corresponding prediction information in the prediction information storage unit 120 based on the extracted words. Although the prediction information is described as being searched in the prediction storage unit 120, aspects of the invention are not limited thereto, such that the prediction information may be stored independently in a separate terminal or a server. More specifically, using the two words, ‘Hong Kil-dong’ and ‘phone number,’ the analyzer 112 may search for prediction information based on these two words. The analyzer 112 may recognize that a received text input refers to a phone number of a contact named called Hong Kil-dong or another contact called, for example, Pan-teak based on the searched prediction information.

The interoperation request unit 130 may decide interoperational capability with an application program based on the prediction information received from the analyzer 112. The interoperation request unit 130 may determine an indication or contextual information of the text input received from the detector 111 based on the prediction information received from the analyzer 112. The interoperation request unit 130 may determine whether interoperation with other application program is possible, which may be based, at least in part, on the indication or contextual information of the received text input. The interoperation request unit 130 may determine whether interoperation with other application program is possible, and search to identify one or more application programs that may be suitable for interoperating with the predicted contents among one or more application programs that may be stored in a mobile terminal. The interoperation request unit 130 may select an interoperable application program based on the received prediction information. According to aspects of the invention, received prediction information may be based on reference information, which may be preset in one or more application programs. Further, the received prediction information may be based on whether there is an application program related to content or contextual information corresponding to the received prediction information.

For example, when the analyzer 112 predicts or determines that a phone number of a target or contact having a name of Hong Kil-dong based on the extracted text or words of ‘Hong Kil-dong’ and ‘phone number’, the interoperation request unit 130 may determine a relationship between the extracted words and an address book application program storing a phone number. More specifically, the interoperation request unit 130 may check or determine whether the address book application program stores contact information or phone number corresponding to the target or contact having the name of Hong Kil-dong. For example, when the address book application program stores contact information or phone number of the target having the name of Hong Kil-dong, the interoperation request unit 130 may decide interoperation may be possible with the address book application program, which includes a phone number of a contact named Hong Kil-dong or another contact called, for example, Pan-teak. Further, when the name of Hong Kil-dong is not found from the address book application program, the interoperation request unit 130 may provide an auto-complete operation based on the prediction information without interoperating with other application program.

For example, when it is determined that the prediction information received from the interoperation request unit 130 is interoperable with the other application program, the interoperation request unit 130 may generate an interoperation request signal, and transfer the interoperation request signal to an application program 150, which may be determined to be interoperable with the text input received through a different application program. The interoperation request signal may include, without limitation, at least one of data for interoperating an application program and an application program interoperation request based on the prediction information. When it is determined that prediction information based on the received text input is interoperable with an application program other than the application program that may have provided the respective text input, the interoperation request unit 130 may select one or two application programs to interoperate from among one or more stored application programs, and may transfer the interoperation request signal to the selected application programs.

Moreover, the interoperation request unit 130 may generate a prediction list using an auto-complete operation or an auto-correction operation based on the received prediction information, and may transfer the prediction list to the processing unit 140. The prediction list may include a list of one or more potential prediction words, sentences, phrases, files, images, and the like in view of the interoperation data. The auto-complete operation or the auto-correction operation may refer to an operation that identifies a candidate of a succeeding word or sentence, while a user may be in the middle of inputting text data, when text data of from the foremost part to an input part is the same previously-input word or sentence. At least one of the auto-complete operation and the auto-correction operation may generally be used when inputting text, such as inputting of a keyword on a webpage or sending an SMS, and may remove some inconvenience of re-inputting a long text string and may reduce input errors. The prediction list may refer to a list including one or more words or sentences that may be predicted by the auto-complete operation based on the received prediction information. However, aspects of the invention are not limited thereto, such that the prediction list may include a list of words, sentences, files, images, dates, times, schedule information, and the like. Further, prediction list may be generated in view of the interoperation data of the interoperation application program.

The application program 150 may denote one or more application programs stored in a terminal. The application program 150 may include some or all of various application programs, which may be used in personal computers (PCs), smart devices, and the like.

An application program 150, receiving the interoperation request signal from the interoperation request unit 130, among the one or more application programs that may be stored in a terminal, may be executed to generate interoperation data according to the received interoperation request signal. The interoperation data may include an interoperated application program itself or an execution result of the interoperated application program.

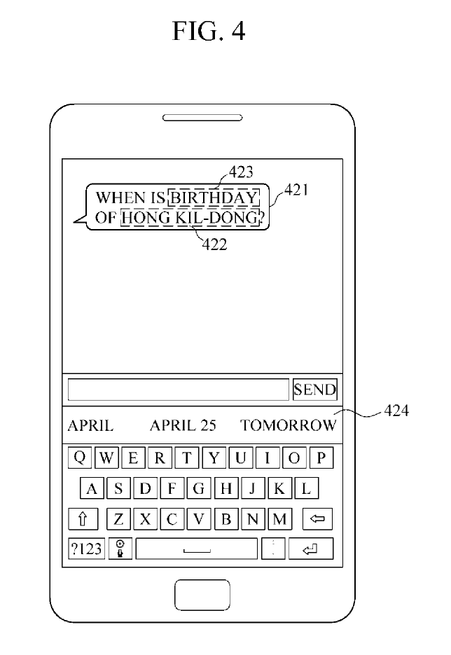

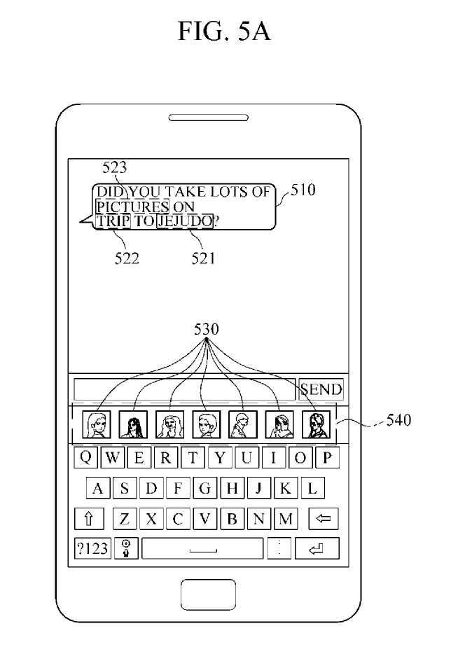

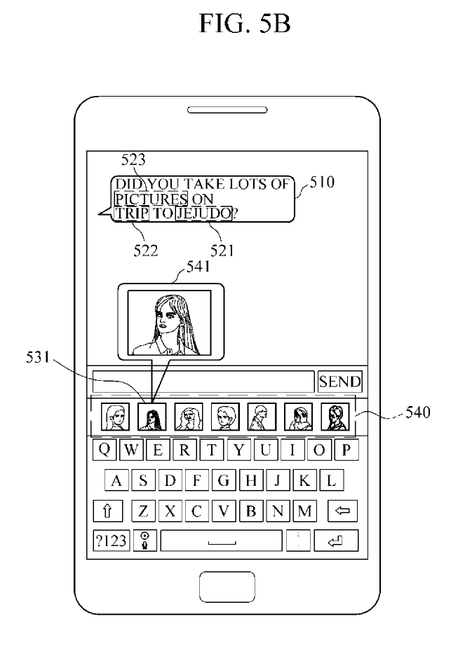

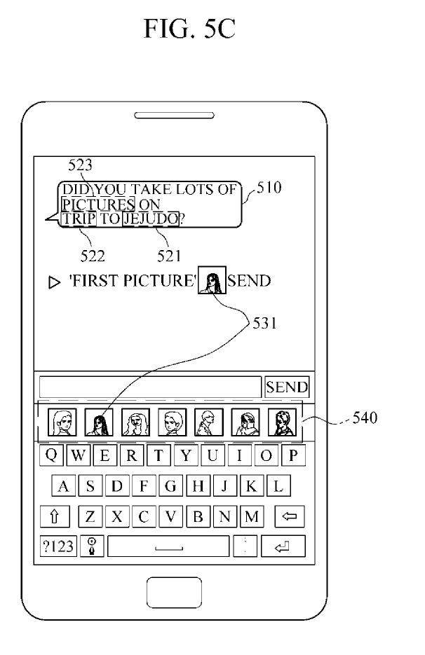

For example, when an interoperation request signal that requests a phone number of a target having a name of Hong Kil-dong is received from the interoperation request unit 130 to an address book application program, the address book application program may search a plurality of stored phone numbers to find the phone number corresponding to Hong Kil-dong. Further, the address book application program may generate interoperation data including the found phone number of Hong Kil-dong or may generate interoperation data including an address book application program indicating the phone number of Hong Kil-dong. Although a phone number request and interoperation with an address book application program corresponding to the phone number request are described, aspects of the invention are not limited thereto, such that it may be possible to interoperate with various application programs. A detailed description of an interoperation application program will be described with reference to FIG. 4 and FIG. 5 below. The application program 150 may generate interoperation data and transfer the generated interoperation data to the processing unit 140.

The processing unit 140 may generate interface data based on the prediction list received from the interoperation request unit 130 and the interoperation data received from the application program 150, and may transfer the interface data to an image display unit 160. The processing unit 140 may determine a user interface for displaying execution results (e.g., prediction information or a prediction list) in consideration of the interoperation data received from the application program 150. For example, when an interface of an interoperated application program is displayed on a screen as-is, the interface of the interoperated application may partially or totally cover or obstruct a screen of an application program being currently used. However, aspects of the invention are not limited thereto, such that the processing unit 140 may not provide or display the user interface of the interoperated application program 150 as a whole, but instead may provide an execution result of the interoperated application program 150 or interoperated data through an integrated input interface. The integrated input interface may integrate portions of a user interface corresponding to an application program for exchanging text data and a user interface corresponding to the interoperated application program 150.

The processing unit 140 may provide execution result of the interoperated application program 150 using an integrated input interface. The processing unit 140 may generate an integrated input interface, which may include the execution result of the interoperated application program 150 and an input interface of a messenger application program, such as a virtual keypad. More specifically, the processing unit 140 may generate an interface to display execution result of the interoperated application program 150 within or over a certain area of a text input area of a text-based application program. Further, the processing unit 140 may display interoperation data received from the interoperated application program 150 on a screen of a terminal (e.g., data 424 of FIG. 4 or data 540 of FIG. 5A). The text input area may denote an area or interface in which a text may be inputted to the mobile device by an input of the user, such as a virtual keypad of a mobile messenger. For example, when interoperating with the phone number of Hong Kil-dong, an interface may be added to a portion of a virtual keypad, such as an upper portion, to provide an integrated input interface for displaying the phone number of Hong Kil-dong.

The interoperation data received from the interoperated application program 150 may include one or more execution results of predicted contents. For example, when the received interoperation data does not include one piece of data but includes two or more pieces of data, the processing unit 140 may set a portion of an integrated input interface as a recommendation list, which may include some or all pieces of data (e.g., see data 424 of FIG. 4). The user may select corresponding data from among the pieces of data included in the recommendation list. A more detailed description of the integrated input interface will be described with reference to FIG. 4 and FIG. 5 to be described below.

The processing unit 140 may generate an integrated input interface data for interoperating the application program 150, and transfer the input device interface data to the image display unit 160. The image display unit 160 may display a user interface, which may include, without limitation, one of the execution result of the interoperated application program 150 or the prediction list, on a screen based, at least in part, on the integrated input interface data received from the processing unit 140.

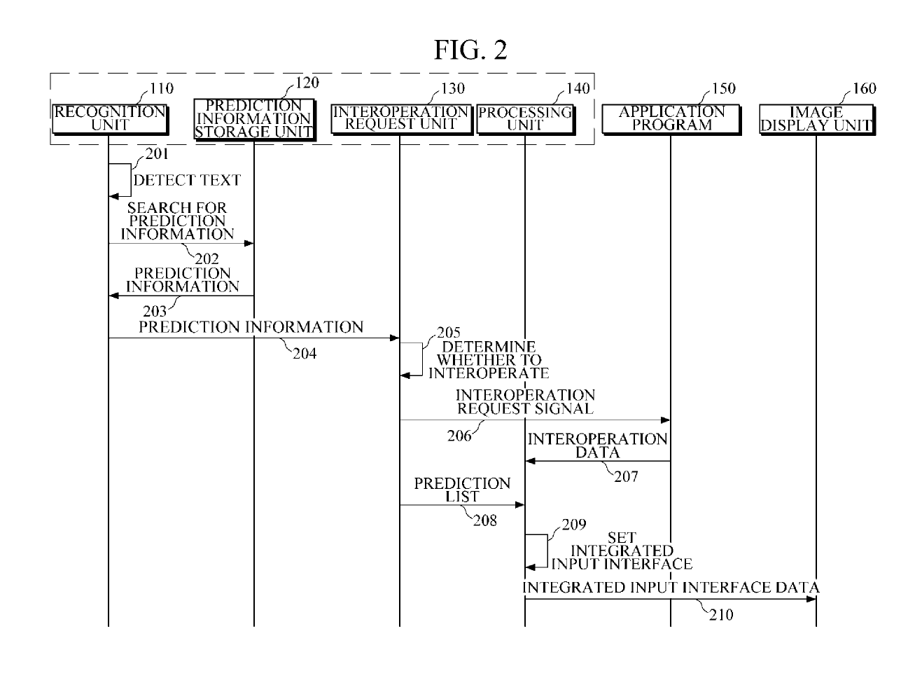

FIG. 2 is a flowchart illustrating a data flow for providing input prediction service according to an exemplary embodiment of the present invention.

Referring to FIG. 2, in operation 201 of the data flow for providing input prediction service in a first mobile terminal, a text is first detected from a message received from another party or a second mobile terminal. The message may be received using a first application program, which may be a text based messenger program. More specifically, in addition to a message which may be inputted in the first mobile terminal by a user, the message received from the second mobile terminal is detected. The recognition unit 110 may recognize the received message to detect a plurality of texts included in the message, and parse the detected plurality of texts to extract one or more specific words.

In operation 202, the prediction information of the prediction information storage unit 120 may be searched based, at least in part, on one or more extracted words in operation 202. The prediction information may include, without limitation, information predicted according to a combination of extracted words. However, aspects of the invention are not limited thereto, such that prediction information may also include information predicted according to a combination of word(s), images or files, received, weblinks, and the like. The information predicted may include at least one of potential word(s), phrase(s), contact information, date(s), image(s), file(s), sentence(s) or the like. The prediction information storage unit 120 may transfer the searched prediction information to the recognition unit 110 in operation 203. The recognition unit 110 may predict a word, a phrase, or a sentence based on the received prediction information. More specifically, the recognition unit 110 may predict a word, a phrase, or a sentence using the extracted words. Further, the recognition unit 110 may predict a complete word, phrase or a related word of the extracted word using one extracted word. In operation 204, the recognition unit 110 transfers prediction information, which may predict at least one of a word, a phrase, or a sentence, to the interoperation request unit 130.

In operation 205, the interoperation request unit 130 determines whether to interoperate with a second application program, other than the first application program used to receive the message from the second mobile terminal, based on the received prediction information. The interoperation request unit 130 may predict or determine an indication, a context, or an intent of the received message based on the received prediction information. Through such prediction, the interoperation request unit 130 may determine whether it may be possible to interoperate with the second application program on the received message. Reference information for determining interoperability, in which the interoperation request unit 130 may select an interoperable application program based on the received prediction information, may be based on information, which may be preset in one or more application programs. Further, the reference for determining interoperability may be based on whether there is an application program related to predicted or determined indication, context, or intent of the received prediction information. A method, which may determine whether interoperation with the second application program is possible, may include, without limitation, at least one of a searching whether there is an application program suitable for predicted contents, which may include at least one of an indication, context, or intent, among one or more application programs stored in a terminal or a mobile terminal.

In operation 206, when it is determined that the prediction information received from the interoperation request unit 130 is interoperable with the second application program, such as the application program 150, the interoperation request unit 130 may generate an interoperation request signal and transfer the interoperation request signal to the application program 150. The interoperation request signal may include, without limitation, at least one of an application program interoperation request and data for interoperating based on the prediction information. The interoperation request unit 130 may select one or more application programs to interoperate from among the stored application programs, and transfer the interoperation request signal to the selected application program(s).

An application program 150, which may receive the interoperation request signal from the interoperation request unit 130, may be executed to generate interoperation data according to the received interoperation request signal. The interoperation data may include an interoperated application program itself or an execution result of the interoperated application program. The application program 150 may transfer the generated interoperation data to the processing unit 140 in operation 207.

In operation 208, the interoperation request unit 130 generates a prediction list, and transfers the prediction list to the processing unit 140. The interoperation request unit 130 may generate the prediction list using an auto-complete operation, which may use the received prediction information, and transfer the prediction list to the processing unit 140. The prediction list may refer to a list of words or sentences, which may be predicted by the auto-complete operation based on the received prediction information.

In operation 209, the processing unit 140 may set an integrated input interface based on the received interoperation data and the prediction list. The processing unit 140 may set the integrated input interface for providing an operation of the interoperated application program. The integrated input interface may incorporate a portion of a user interface corresponding to the interoperated application program (e.g., the second application program) and a portion of a user interface corresponding to the first application program. The user interface corresponding to the interoperated application program may include an interface to control the application itself, and/or an interface to display the execution results of the interoperated application program.

Further, the processing unit 140 may generate the set integrated input interface for displaying the execution result of the interoperated application program 150. In particular, the processing unit 140 may change the setting of the integrated input interface according to a data type of execution result of the interoperated application program. When the data type of execution result is a text type, the processing unit 140 may provide the execution result in the form of general texts. Also, when the data type of execution result is of a non-text type, such as a photograph, video, voice, and application, the processing unit 140 may display the execution result of the interoperated application program 150 in the input device interface with a preview image (e.g., thumbnail), an icon, or the like.

In operation 210, the processing unit 140 may transfer set input device interface data to the image display unit 160. The image display unit 160 may display the generated integrated input interface, including the execution result of the interoperated application program 150 and/or a prediction list, on a screen of the first mobile terminal.

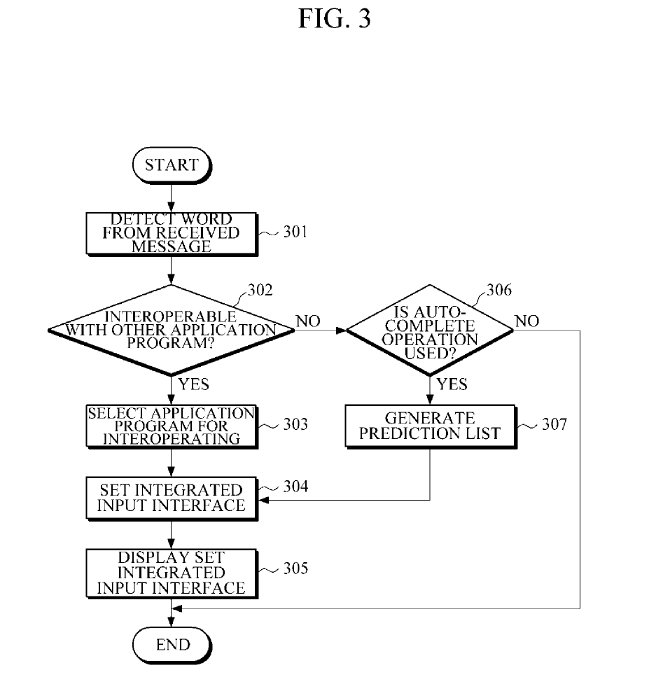

FIG. 3 is a flowchart illustrating a method for providing an input prediction service according to an exemplary embodiment of the present invention.

Referring to FIG. 3, in operation 301, a first mobile terminal detects a text from a message received from a second mobile terminal. The message may be received using a first application program. The first mobile terminal may recognize the received message to detect a plurality of texts included in the received message. Further, the first mobile terminal may detect text included in the received message along with texts that may be generated by the first mobile terminal. In detecting the received message, in addition to a text inputted into the first mobile terminal by its user, a message received from the second mobile terminal is detected. The first mobile terminal may parse the plurality of detected texts to extract one or more words. However, aspects of the invention are not limited thereto, such that letters, phrases, sentences may be also extracted.

In operation 302, the first mobile terminal determines whether it is possible to interoperate with a second application program based on the received message. The first mobile terminal may search the prediction information storage unit 120 based on the one or more extracted words to find corresponding prediction information. Further, the first mobile terminal may determine context information of the received message based on the searched prediction information. Using the determined context information, the first mobile terminal may determine whether it is possible to interoperate with the second application program to provide an input prediction service based on the received message. A reference for determining interoperability, which may determine whether it is possible to interoperate with the second application program may be based on a reference preset in one or more application programs, or based on whether there is an application program related to predicted contents of the received prediction information. The first mobile terminal may determine whether interoperation with the second application program is possible based on at least one of the determined context information and the set reference information corresponding to the second application program. The second application program may be selected among one or more application programs stored in the first mobile terminal.

When it is determined in operation 302 that it is possible to interoperate with the second application program, an application program for interoperating, or the second application program, is selected in operation 303. When the first mobile terminal determines that it may be possible to interoperate with the second application program, the first mobile terminal may selects the second application program for interoperating from among one or more application programs. The selected application program may output an execution result based on the one or more words extracted from the received message.

In operation 304, the first mobile terminal sets an integrated input interface for providing an interoperated application program. More specifically, when the interoperated application program or the second application program is selected, the first mobile terminal may set an integrated input interface for outputting an execution result of the interoperated application program. Since the normal user interface of the second application program may obstruct the use or display of the first application program, an integrated input interface may be provided. For example, when a phone number of a specific target is searched for and identified through an address book application program during sending and/or receiving a text message to and/or from a friend through a mobile messenger, a user interface of an address book being executed may partially or totally cover a user interface of the mobile messenger being currently executed. The integrated input interface, which may incorporate portions of user interfaces corresponding to the first application program and the second application program, may provide a user interface which may allow a user to use or view the first application program with less obstruction.

More specifically, the first mobile terminal may set an integrated input interface according to the execution result of the interoperated application program, and may provide the set integrated input interface to the user. The execution result of the interoperated application program may have various data types. When the execution result has a simple text-based data type, such as a phone number of a specific target of an address book, the first mobile terminal may output a corresponding text as the execution result in the integrated input interface, which may include a keypad of the first application program. For example, when the execution result of the interoperated application program includes one or more results, the first mobile terminal may generate a recommendation list including some or all of the execution results, and provide the recommendation list through the integrated input interface. In operation 305, the first mobile terminal may display the set integrated input interface. The first mobile terminal may display an integrated input interface including the execution result of the interoperated application program on a screen based on the set integrated input interface data. However, when it is determined in operation 302 that interoperation with the other application program may not occur, the first mobile terminal may determine to use the auto-complete operation in operation 306. More specifically, when the first mobile terminal determines not to interoperate with the second application program, the first mobile terminal may predict a related word or sentence, or a complete word or sentence, using an auto-complete operation to provide the prediction information or predicted result. When the auto-complete operation is not used in operation 306, providing of a prediction service is terminated.

For example, when the auto-complete operation is used in operation 306, the first mobile terminal generates a prediction list in operation 307. The first mobile terminal may predict at least one of a word, a phrase, and a sentence related to a received message using the auto-complete or auto-correction operation. Further, the first mobile terminal may generate a prediction list including the predicted word and/or sentence. In operation 304, the first mobile terminal may set a user interface based on the prediction list. A method for setting the user interface based on the prediction list is the same as or similar as that of the above-described operation 304. The first mobile terminal may set an integrated input interface in order for the prediction list to be displayed for input along with an input interface of the first application program, such as a virtual keypad. The first mobile terminal displays the set integrated input interface on a screen of the first mobile terminal in operation 305.

FIG. 4 is a diagram illustrating an input device interface to provide an input prediction service according to an exemplary embodiment of the present invention.

Referring to FIG. 4, an integrated input interface for interoperating with a scheduling application program or the second application program is provided. When message 411 of ‘When is birthday of Hong Kil-dong?’ is received through a messenger application program or a first application program, the first mobile device may detect words ‘Hong Kil-dong’ 412 and ‘birthday’ 413 from the received message 411. The message 411 may be received from a second mobile device. The scheduling application program may be selected as an application program for interoperating based on the detected words ‘Hong Kil-dong’ 412 and ‘birthday’ 413. The first mobile device may search for a schedule corresponding to ‘Hong Kil-dong’ 412 and ‘birthday’ 413 in the scheduling application program. When the birthday of Hong Kil-dong is searched and identified as April 25 in the scheduling application program, integrated input interface 424 for providing an input prediction service displays the identified schedule or date of April 25 as the birthday of Hong Kil-dong. The integrated input interface 424 is placed in a keypad area of a text input area of the messenger application program or the first application program as illustrated in FIG. 4. When the first mobile terminal determines that a text is inputted or received, the integrated input interface may be displayed in the integrated input interface, which includes the keypad of the messenger application program. The user can check or select a schedule corresponding to the content or contact included in the received message, such as birthday of Hong Kil-dong, through the integrated input interface, which may be provided with little or no obstruction to a screen of the mobile messenger application program. The integrated input interface may be displayed in an area of an input interface (e.g., a keypad) of the first application program. Referring to FIG. 4, a portion of the integrated input interface for displaying prediction information or execution result of the second application program is placed in an upper end portion of the virtual keypad. However, aspects of the invention are not limited thereto, such that the respective portion of the integrated input interface is not limited to the upper portion of the keypad, and the respective portion of integrated input interface may be placed at various positions within the integrated input interface or may be placed separately from the portion of the integrated input interface corresponding to the first application program.

FIG. 5A, FIG. 5B, and FIG. 5C are diagrams illustrating an integrated input interface to provide an input prediction service interoperating with a gallery application program according to an exemplary embodiment of the present invention.

More specifically, FIG. 5A illustrates a preview type integrated input interface, FIG. 5B illustrates an integrated input interface, which has a capability to enlarge a preview image, and FIG. 5C illustrates an integrated input interface, which allows sharing of an image file corresponding to the preview image displayed in the integrated input interface.

Referring to FIG. 5A, FIG. 5B, and FIG. 5C, when a message 510 of ‘Did you take lots of pictures on the trip to Jejudo?’ is received, the first mobile device may detect words ‘Jejudo’ 521, ‘trip’ 522, and ‘picture’ 523 from the received message 510. The gallery application program, which may display various images or pictures, may be selected as an application program for interoperating, or the second application program, based on the detected words ‘Jejudo’ 521, ‘trip’ 522, and ‘picture’ 523. The first mobile device searches for a photograph corresponding to ‘Jejudo’ 521 and ‘trip’ 522 in the gallery application program. An integrated input interface 540, which may provide a preview of an image, such as a thumbnail, is placed an upper end portion of a virtual keypad or a lower end of a display, and displays a plurality of searched or identified pictures 530 as preview images in the integrated user interface 540. A user can select a picture corresponding to the received message through the integrated input interface 540.

The plurality of pictures 530 displayed in the integrated input interface 540 may enable a displayed preview image thereof to be selected. Further, referring to FIG. 5B, one of the preview images, such as a preview image 531 may be enlarged to be displayed as an enlarged preview image 541. By enlarging the first preview image 531 included in the plurality of pictures displayed in the integrated input interface 540, the user may be able to see a more accurate view of a selected image or picture.

Referring to FIG. 5C, the user may select the first preview image 531 from among the plurality of preview images displayed in the integrated input interface 540, and share a picture file corresponding to the first preview image 531 with the other party, such as a second mobile terminal, which may exchange a message with the first mobile terminal. Accordingly, exemplary embodiments of the present invention can alleviate some inconvenience of having to additionally execute the gallery application program or other application program to share a predicted picture.

Table 1 shows various examples of an input prediction service. A text type execution result of one or more of the address book application, the scheduling application program, and a dictionary application program may be displayed on a screen through various integrated input interfaces. An integrated input interface may be provided for the input prediction service, which may include various types of execution results, such as a video or voice, as well as an image type execution result of the gallery application program.

TABLE 1
Examples of an input prediction service:

| | | | | Interoperate application | | | |
|---|---|---|---|---|---|---|---|
| Received message | | Detect word | | program | | Execution result | |
| What is phone | | 1. | Hong Kil- | 2. | Address book | 3. | 010-123-4567 |
| number of Hong Kil- | | | dong, phone | | application | | |
| dong? | | | number | | program | | |
| 4. | What is | 5. | March 17, | 6. | Scheduling | 7. | Schedule on |
| | schedule on | | schedule | | application | | March 17 |
| | March 17? | | | | program | | |
| 8. | What does | 9. | Sweet after | 10. | Dictionary | 11. | No gain |
| | sweet after | | bitter, | | application | | without pain |
| | bitter mean? | | meaning | | program | | |
| 12. | Whose phone | 13. | 010-123- | 14. | Address book | 15. | Hong Kil- |
| | number is | | 4567, phone | | application | | dong |
| | 010-123- | | number | | program | | |
| | 4567? | | | | | | |
| 16. | Show a picture | 17. | 17th, picture | 18. | Gallery | 19. | Provide |
| | took from trip | | | | application | | picture took on |
| | on 17th. | | | | program | | 17th in the |
| | | | | | | | form of |
| | | | | | | | thumbnails |

Although various examples of integrated input interface are illustrated in FIG. 4 and FIG. 5, aspects of the invention are not limited thereto, such that various input prediction service may be used. An integrated input interface may be used or selected in consideration of various factors, such as contents of a message, an application program being currently used, an interoperated application program, user setting, and the like.

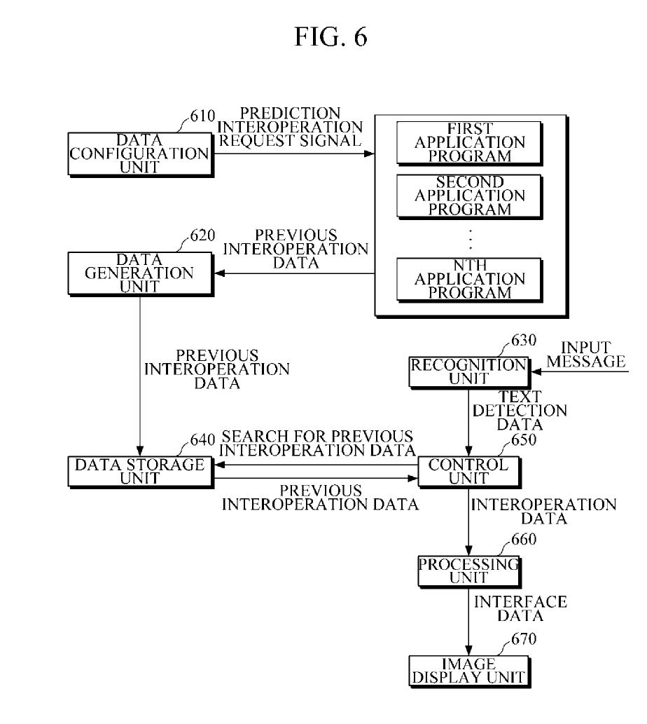

FIG. 6 is a diagram illustrating an apparatus to provide an input prediction service using a pre-interoperation scheme according to an exemplary embodiment of the present invention.

Referring to FIG. 6 and FIG. 1, in the input prediction service providing apparatus 100 of the first mobile device, the recognition unit 110 may search the prediction information storage unit 120 based on the received message. The interoperation request unit 130 may search for to identify an application program to interoperate based on the searched prediction information and may interoperate with the identified application program. Further, when an application program that sends and receives text-based data, such as a messenger application program is executed, the input prediction service providing apparatus of the first mobile device may receive data used for interoperation from a plurality of application programs included in the first mobile device, and may store the received data in a database. Further, the input prediction service providing apparatus may also store data used for interoperation based on previous interoperations with the corresponding application program. When a message is received from a second mobile terminal, the input prediction service providing apparatus in the first mobile terminal may not check to determine whether an application program capable of interoperating with a specific application program (e.g., messenger application program) as in FIG. 1 but may search for data stored in the database to find data used for interoperation. By using the stored interoperation data, the first mobile terminal may reduce delay in identifying the interoperable application programs.

An input prediction service providing apparatus 600 of the mobile device using the pre-interoperation scheme includes a data configuration unit 610, a data generation unit 620, a recognition unit 630, a data storage unit 640, a control unit 650, and a processing unit 660.

When a first application program for exchanging (e.g., sending and/or receiving) text data, such as a mobile messenger is executed or an interface for inputting a text, such as a virtual keyboard, is activated, the data configuration unit 610 may transfer a prediction interoperation request signal to a plurality of application programs included in the input prediction service providing apparatus 600. The prediction interoperation request signal may request previous interoperation data for interoperating with application program 150, which may be predetermined to be interoperable with one or more words included in the message received from at least one of the first application program and the second application program.

The previous interoperation data, which may be included in one or more of the plurality of application programs receiving the prediction interoperation request signal from the data configuration unit 610, may be transferred to the data generation unit 620. The previous interoperation data may refer to interoperation data stored in one or more application programs, which may indicate which of the stored application programs are determined to be interoperable with the text included in the message received from at least one of the first mobile terminal and the second mobile terminal. For example, an address book application program may be determined to interoperate with the first application program to transfer a plurality of stored phone numbers and addresses, and a scheduling application program may be determine to interoperate with the first application program to transfer stored information on a plurality of schedules.

The data generation unit 620 may store previous interoperation data corresponding to one or more application programs stored in the first mobile terminal. Also, the data generation unit 620 may transfer the stored interoperation data to the data storage unit 640.

The data storage unit 640 may store the interoperation data received from the data generation unit 620. The data storage unit 640 may transfer the stored interoperation data to the processing unit 650 according to a request received from the processing unit 650.

The recognition unit 630 may perform an operation similar to that of the recognition unit 110 of FIG. 1. When a message is received, the recognition unit 630 may detect a text from the received message. In detecting a received text, the recognition unit 630 may detect a text input from a user, who may input the text using a first mobile terminal, and may detect a text received from the other party or the second mobile terminal. The recognition unit 630 may recognize the received message to detect a plurality of texts included in the message. For example, when a message is received from the second mobile terminal through a mobile messenger, the recognition unit 630 may detect some or all words included in the received message. The recognition unit 630 may generate text detection data, which may include one or more detected words, and transfer the text detection data to the control unit 650.

The control unit 650 may perform an operation similar to that of the interoperation request unit 130 of FIG. 1. The control unit 650 may search for interoperation data stored in the data storage unit 640 in view of the received text detection data. The control unit 650 may identify and request interoperation data corresponding to a second application program, which may interoperate with the received message. In FIG. 1, the interoperation request unit 130 may directly request interoperation data from one or more application programs, but in FIG. 6, the control unit 650 may retrieve the corresponding interoperation data of plurality of application programs from the data storage unit 640. Therefore, the control unit 650 may access, directly or indirectly, the data storage unit 640 to search for interoperation data without calling or accessing one or more application programs. For example, when a received message includes words ‘What is the phone number of Hong Kil-dong’, the control unit 650 may detect words ‘Hong Kil-dong’ and ‘phone number’. The control unit 650 may search the data storage unit 640 to find interoperation data corresponding to an application program that is known to be interoperable with text ‘Hong Kil-dong’ and ‘phone number’ included in received text detection data.

The control unit 650 may generate interoperation data for interoperating with a received text input based on the interoperation data received from the data storage unit 640. For example, when the searched interoperation data includes 010-123-4567 as the phone number of a contact with the name of Hong Kil-dong, the control unit 650 may generate interoperation data including information on the phone number. The control unit 650 may transfer the generated interoperation data to the processing unit 660.

The processing unit 660 may perform an operation similar to that of the processing unit 140 of FIG. 1. The processing unit 660 may set an integrated input interface based on the received interoperation data. The processing unit 660 may generate the set integrated input interface based on the received interoperation data, and may provide the generated integrated input interface. More specifically, the processing unit 660 may change the setting of the integrated input interface according to a data type of execution result of the interoperated application program. For example, when the data type of execution result is determined to be a text type, the processing unit 660 may provide the execution result in the form of general texts. Also, when the data type of execution result is determined to be a non-text type, such as a photograph, video, voice, and application, the processing unit 660 may provide the execution result of the interoperated application program to a user in the form of a preview image or file. The integrated input interface may display interoperation data in a partial area of the integrated input interface including a virtual keypad. Further, the processing unit 660 may transfer set integrated input interface data to the image display unit 670. The image display unit 670 may display an integrated input interface, which may indicate or display interoperation data based on prediction information received from the processing unit 660.

According to aspects of the invention, a first mobile terminal may recognize a message sent and received in an operation of sending and receiving a text-based message, and determine prediction information and/or an execution result by automatically interoperating with an application program. Further, the first mobile terminal may be provided with a service that displays the predicted result or the prediction information on a screen. Accordingly, the first mobile terminal may check or select prediction information using automatically-displayed prediction information without separately executing an additional application program.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing an input prediction service in a first mobile terminal, the method comprising:
receiving a message, from a second mobile terminal, at the first mobile terminal using a first application program;
extracting specific text included in the received message; and
identifying prediction information based on the extracted text.

2. The method of claim 1, wherein the prediction information comprises at least one of a word, contextual information, and a sentence based on the extracted text.

3. The method of claim 1, further comprising:
determining whether a second application program is interoperable with the extracted text based on the prediction information; and
selecting the second application program for interoperating with the extracted text.

4. The method of claim 3, wherein the second application is selected based on contextual information of the extracted text.

5. The method of claim 3, further comprising:
obtaining interoperation data of the second application program,
wherein the interoperation data comprises an execution result of the second application program based on the extracted text.

6. The method of claim 3, further comprising:
generating an integrated input interface for displaying a prediction list,
wherein the integrated input interface comprises a portion of a user interface corresponding to the first application program and a portion of a user interface corresponding to the second application program.

7. The method of claim 6, wherein the prediction list is provided using the interoperation data of the second application program.

8. The method of claim 6, wherein the prediction list comprises at least one of scheduling information, a date, a time, and contact information.

9. The method of claim 6, wherein the prediction list comprises at least one of a preview image of a file, in which the preview image is capable of being enlarged.

10. The method of claim 6, wherein the integrated input interface is used to transmit a file included in the prediction list to the second mobile terminal.

11. The method of claim 3, further comprising:
generating an integrated input interface comprising a portion of a user interface corresponding to the second application program.

12. The method of claim 1, wherein an auto-complete operation is used to determine a prediction list.

13. The method of claim 1, wherein the prediction information is stored in the first mobile terminal for retrieval.

14. An apparatus to provide an input prediction service in a first mobile terminal, the apparatus comprising:
a first application program to receive a message from a second mobile terminal; and
a recognition unit to extract specific text included in the receive message, and to identify prediction information based on the extracted text.

15. The apparatus of claim 14, further comprising:
an interoperation request unit to determine whether a second application program is interoperable with the extracted text using the prediction information, and to select the second application program for interoperating with the extracted text.

16. The apparatus of claim 15, further comprising:
a processing unit to obtain interoperation data of the second application program, and to generate a prediction list using the interoperation data,
wherein the interoperation data comprises an execution result of the second application program based on the extracted text.

17. The apparatus of claim 16, further comprising:
a display unit to display the prediction list using an integrated input interface,
wherein the integrated input interface comprises a portion of a user interface corresponding to the first application program and a portion of a user interface corresponding to the second application program.

18. The apparatus of claim 14, further comprising:
a processing unit to generate a prediction list using an auto-complete operation.

19. An apparatus to provide an input prediction service in a first mobile terminal, the apparatus comprising:
a first application program to receive a message from a second mobile terminal;
a recognition unit to extract specific text included in the receive message, and to identify prediction information based on the extracted text;
a data storage unit to store interoperation data of a second application program; and
a processing unit to retrieve interoperation data of the second application program, and to generate a prediction list using the interoperation data.

20. The apparatus of claim 19, wherein the interoperation data of the second application program is pre-stored in the data storage unit or stored based on prior use of the interoperation data.
